(19) United States
(12) Patent Application Publication
(10) Pub. No.: US 2011/0045442 A1
(43) Pub. Date: Feb. 24, 2011

(54) Methods and Apparatus for Producing Dental Stones Base Plates Used in Making Dentures

(76) Inventors: Prasad Adusimilli, Parsippany, NJ (US); Stanley J. Lech, Parsippany, NJ (US); ZVi G. Loewy, Parsippany, NJ (US)

Correspondence Address: GlaxoSmithKline;GLOBAL PATENTS -US, UW2220, P. O. BOX 1539, KING OF PRUSSIA, PA, 19406-0939, US

(21) Appl. No.: 12/918,340

(22) PCT Filed: Feb. 20, 2009
(86) PCT No.: PCT/US09/34759

§ 371 Date: Aug. 19, 2010

Related U.S. Application Data
(60) Provisional application No. 61/030,802, filed on Feb. 22, 2008.

(51) Int. Cl. A61C 13/007; G06F 19/00

(52) U.S. Cl. 433/201.1; 700/97

(57) ABSTRACT

This disclosure relates to a method for rapidly producing stone models used in manufacturing dentures. In particular, the method utilizes computer aided design and computer aided manufacturing.

### BACKGROUND OF THE INVENTION

1. Field of the Invention

The present disclosure relates to methods for using computer-aided design and manufacturing techniques for more rapidly and efficiently producing stone models and base plates used in making dentures. More particularly, the present disclosure relates to methods and apparatus for improving impressions, stones, and base plates used in making dentures.

2. Description of the Related Art

Full or partial dentures are worn in the mouth to replace missing teeth. Current processes for making dentures involve multiple steps that depend on human observation and measurement of not only the patient's mouth, but also of various iterations of the denture from first model to when it is completed for use by the patient.

Because this is a time and labor-intensive process, and involves a great deal of subjective measurement and design, the resultant denture is not always a good fit for user and can only be minimally customized. Also, due to slight incorrect sizing or fit, the resulting denture frequently causes problems for the patient, including sore spots, lack of hold and retention, bacterial growth that may lead to malodor, and associated health problems. Aside from these potential problems, the aesthetics of the denture may be compromised.

Thus, in the manufacture of any denture, the fit of the denture to the patient's gum is critical. Fit is greatly determined by the steps taken by the dentist to correctly evaluate and reproduce the anatomy of the gum and transfer that information to the denture manufacturer. The denture manufacturer has to replicate that information in the denture. Heretofore, this process has been accomplished by the creation and transfer between the dentist and denture manufacturer of physical models. The current process for denture making involves taking an impression of the gum on each of the upper and lower jaws and then creating “complimentary” stone models of the jaws, including gums, from the impressions. As used herein, the term “complimentary” means matching the hills and valleys of one (e.g., the gums) with the valleys and hills of another (e.g., the stone model).

The stone models are made by surrounding the impression material with a metal ring to form a boxed impression, mixing powdered stone with water to create a uniform mass, pouring the stone slurry into the boxed impression, and allowing the stone slurry to harden to form a stone cast. The stone cast is typically duplicated to obtain two to three stone casts for use in various further steps of the denture manufacture process, which in itself can lead to errors because of differences between the stone casts.

Next, the undercuts are removed from the stone cast to form the stone model. More particularly, the undercuts, which are, for example, reflective of grooves found in the upper palate, in the stone cast are blocked with wax to form the stone model.

Once the stone model is prepared, custom base plates are made from the stone model. The gum side of the base plate is complimentary or fits the contours of the gum (as reproduced on the stone model) and the other side of the base plate holds the new teeth. The custom base plate is formed using the stone model by applying a base plate material, such as a thin sheet of acrylic material to the stone model, pressing the material on the stone model to shape the material to the contours of the stone model, cut to fit the area of interest and curing the shaped material in a curing chamber under light. The base plate is also typically duplicated to obtain two to four plates for use in various further steps of denture manufacture process.

Clearly, the above is a very tedious and laborious process. Errors can be introduced at any point during these model preparations, thereby compromising the integrity and quality of the final product dentures. Therefore, there is a need to develop a new, more efficient and cost effective process for making stone models and/or custom base plates used in the denture manufacturing process.

### SUMMARY OF THE DISCLOSURE

The present disclosure provides a method of preparing stone models and base plates using computer aided design and computer aided manufacturing (“CAD/CAM”) technologies.

The present disclosure also provides methods of producing stone models and base plates so that any number of better quality stone models and/or base plates can be manufactured in a much faster time frame using fewer materials than with the current methods.

The present disclosure further provides improvements in the manufacturing of stone models by using new materials that can be activated at the time of use by the dentist and provide easier and quicker stone model preparation.

The present disclosure yet further provides for the use of upper and lower base plates having complimentary structures that are used by the dentist to establish the proper centric relationship and vertical distance between the patient's jaws.

### BRIEF DESCRIPTION OF THE DRAWINGS

FIG. 1 is a schematic depiction of a method according to an exemplary embodiment of the present disclosure for making digital impressions, stone models, and custom base plates.

FIG. 2 is a schematic depiction of a method according to an exemplary embodiment of the present disclosure for making digital base plates.

FIG. 3 is a schematic depiction of a method according to an exemplary embodiment of the present disclosure for making a stone model from thermoplastic materials.

FIG. 4 is a schematic depiction of an apparatus according to an exemplary embodiment of the present disclosure for making stone models from thermoplastic materials.

FIG. 5A is a schematic depiction of another method according to an exemplary embodiment of the present disclosure for making a first custom base plate with a built-in striker plate.

FIG. 5B is a schematic depiction of an alternate of the method of FIG. 5A illustrating the making a second custom base plate with a built-in pin plate.

FIG. 6 is a schematic depiction of another method according to an exemplary embodiment of the present disclosure for making a custom base plate.

FIG. 7 illustrates an exemplary embodiment of pre-formed base plates for use in the embodiment of FIG. 6.

### DETAILED DESCRIPTION OF THE DISCLOSURE

The term “denture(s)” is used herein to refer to a denture or partial denture, artificial teeth, removable orthodontic bridge and denture plates, both upper and lower types, orthodontic retainer and appliance, and protective mouthguard and nightguard to prevent conditions such as bruxism and/or temporomandibular joint (TMJ) disorder.

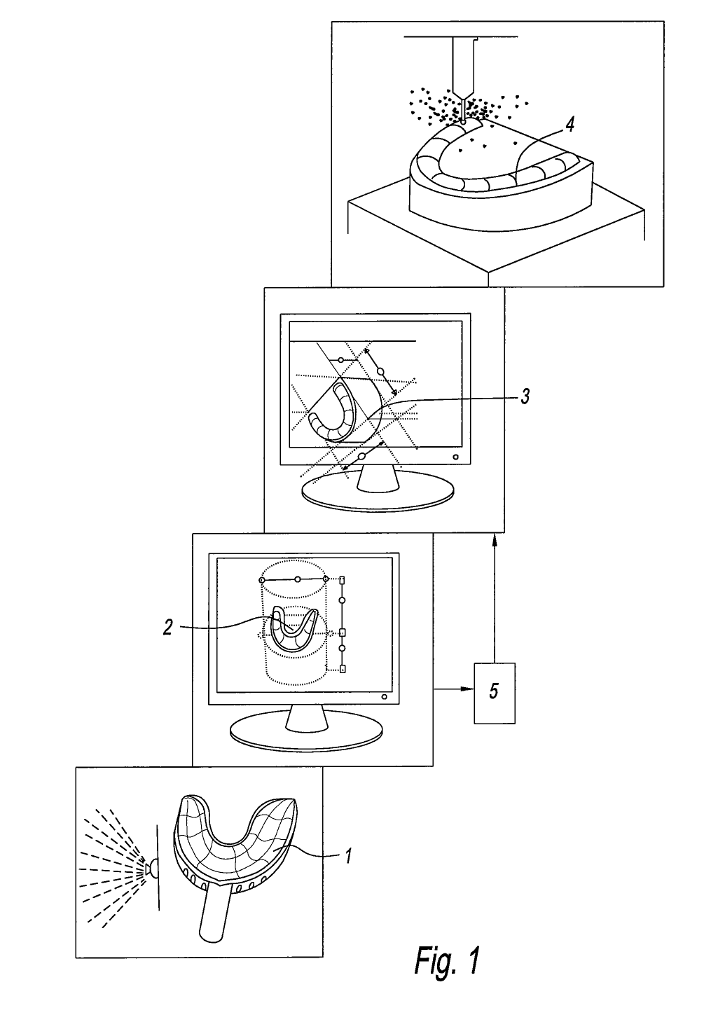

Referring to the drawings and, in particular FIG. 1, a physical impression model 1 of the patient's upper or lower gums are made as described above with respect to the prior art. In accordance with the present disclosure, model 1 is digitally scanned using a three-dimensional (3D) scanner. A digital (or virtual) model 2 of the dental impression is made using suitable CAD technology.

The digital model 2 is entered into a software program 5 of the present disclosure for creating a virtual stone model 3. More particularly, software program 5 converts the digital model 2, which is a negative impression of the patient's gums, to virtual stone model 3, which is a substantial duplicate of the patient's gum contour. In some embodiments, software program 5 is configured so that to manipulate the data during conversion from digital model 2 to virtual stone model 3 so that undercuts, which are, for example, reflective of grooves found in the upper palate, remain present in virtual stone model 3.

The virtual stone model 3 is used to fabricate as many copies of a stone model 4 as needed. For example, stone model 4 can be fabricated from virtual stone model 3 using suitable CAM or rapid prototyping technologies, including those using additive or reductive techniques. Examples of these technologies include, but are not limited to, stereo lithography, fused deposition modeling, multi-jet modeling and laser sintering systems, and computer aided milling (CAM). Thus, stone model 4 can be used as discussed with respect to the prior art to form custom base plates.

Advantageously, stone model 4 includes undercuts formed in impression model 1, where the undercuts are reflective of grooves found in the upper palate. In the current state of the art and as discussed hereinabove, the undercuts on the stone cast are blocked or covered using wax before forming the base plate. The reason for such undercut blocking in prior art stone models is because, when removing prior art base plates from the prior art stone models, pieces of the stone model can fracture off and get stuck in the base plate. Hence, the undercuts are known to compromise on quality of the base plate when using prior art stones. In contrast, it has been determined by the present disclosure that stone model 4, as a result of being made of thermoplastic, overcomes this problem such that the stone model maintains the undercuts. As a result, the resultant base plate made using stone model 4 will also include the undercut profiles, which has been determined by the present disclosure to provide a better quality denture, because the undercuts in the base plate have been found to aid in better fit and retention of the denture on the palate.

In other embodiments, software program 5 is alternately configured to directly fabricate the custom base plate instead of stone model 4. Here, software program 5 converts the digital model 2, which is a negative impression of the patient's gums, to virtual stone model 3, which is a substantial duplicate of the patient's gum contour and leaves the undercuts in the base plate as discussed above. Further, software program 5 converts virtual stone model 3 to a virtual custom base plate model (not shown) and fabricates as many copies of the desired custom base plate as are desired using the aforementioned suitable CAM or rapid prototyping technologies.

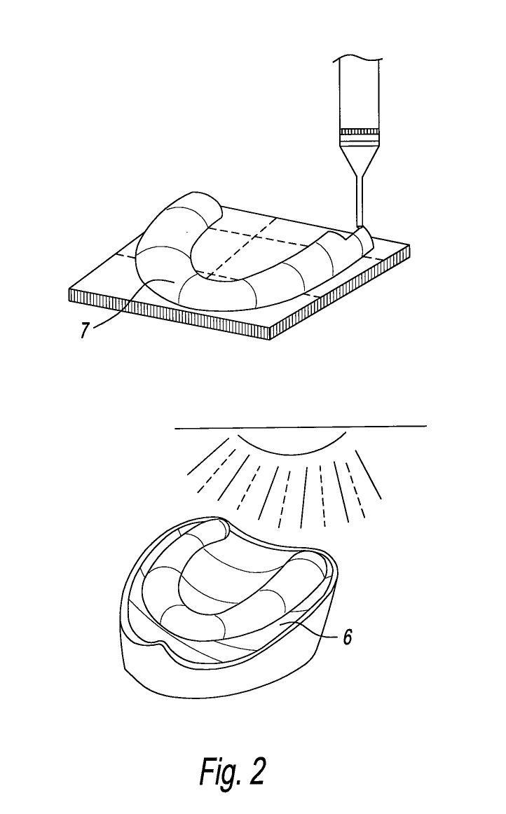

Referring to FIG. 2, a stone model 6, which is fabricated manually according to the prior art stone model making process described above, is digitally scanned using a 3D scanner. One or more duplicates are made using the above-described CAD/CAM technologies. The digital scan of model 6 is then used to fabricate a complimentary base plate 7 using the aforementioned suitable CAM or rapid prototyping technologies.

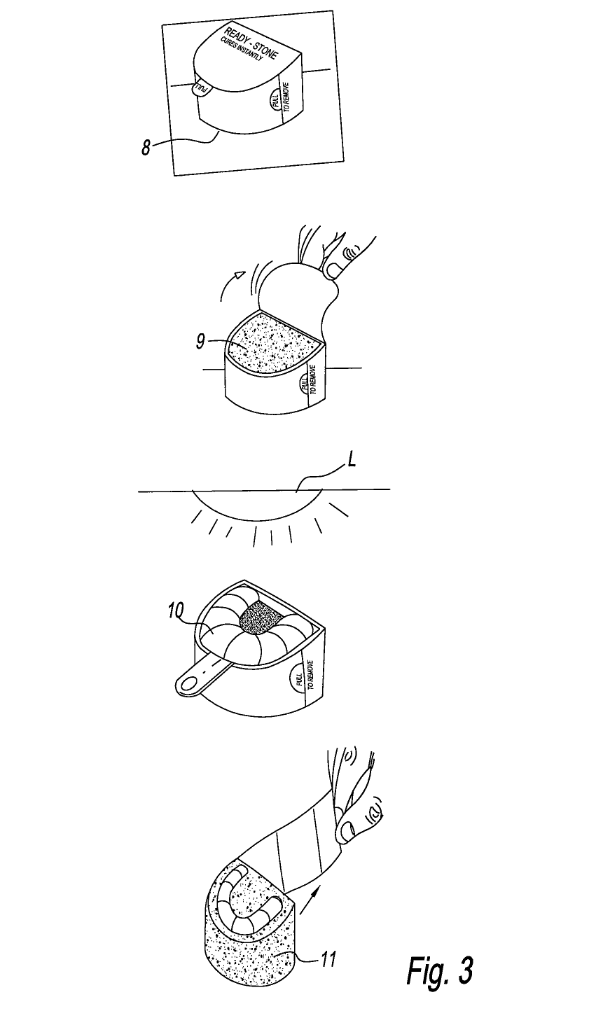

Referring to FIG. 3, there is shown an improved process for manually making stone models, which process is another aspect of the present disclosure. A container 8 holds a semi-solid material 9 from which the stone model will be made. The material 9 is made of a silicone, polymethacrylate, or any plastic that solidifies upon activation, such as by heat, light or moisture. An impression tray 10 is forced into container 8 and displaces material 9. The displaced material 9 will form stone model 11. Once the displaced material 9 becomes solid, the impression tray 10 and container 8 are removed to provide stone model 11. In the illustrated embodiment, displaced material 9 is cured using heat, moisture or light (L) with or without the removal of impression tray 10 from container 8.

By the present disclosure, new materials are contemplated that will allow for easier and less time consuming preparation instead of making a water slurry of gypsum material each time a stone is to be used. Basically, the material chosen can be in a solid state until use and then heated to form a semi-liquid stone material. The polymer or combination of polymers with the least coefficient of thermal expansion are most suitable for these materials. The ideal composition of these polymers will not shrink or expand due to changes in temperature.

Such plastic stone models have many advantages over the current gypsum stone models, since they cannot be scratched, damaged or broken. Also, the number of stone models normally required can be reduced, the fabrication and curing time needed for manufacture is reduced, and the above described process is free of dust and waste of raw materials and can be recycled.

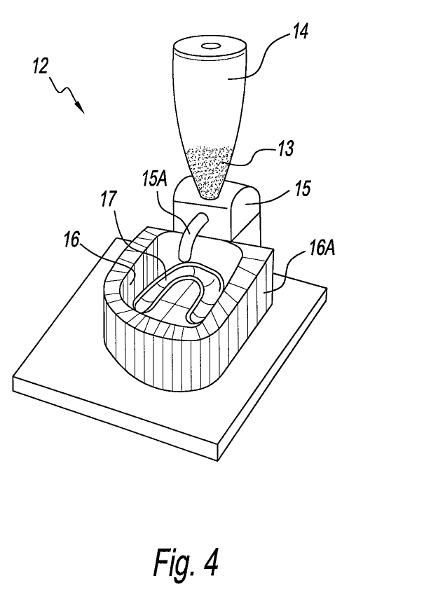

Referring to FIG. 4, the process of fabricating a stone model can be automated using a machine 12. Machine 12 holds plastic material 13 in the form of powder, beads or pellets or granules in a storage chamber 14. Upon demand, machine 12 is programmed to dispense the required amount of material 13 into a heating device 15, which melts the material at the desired temperature and dispenses the molten material through a molten plastic dispenser 15A into a chamber 16 formed by mechanical shaping walls 16A. Impression chamber 16 holds an impression tray 17. Impression chamber 16 can be equipped with one or more sensors to sense the size of impression tray 17 and then properly enclose the impression tray based on the amount of material 13 being used. The material 13 is then cooled, and once the material is formed, the stone model and impression are removed from shaping walls 16A.

This machine 12 also limits the extent of human intervention resulting in a significant reduction labor costs as compared to prior art stone model fabrication processes.

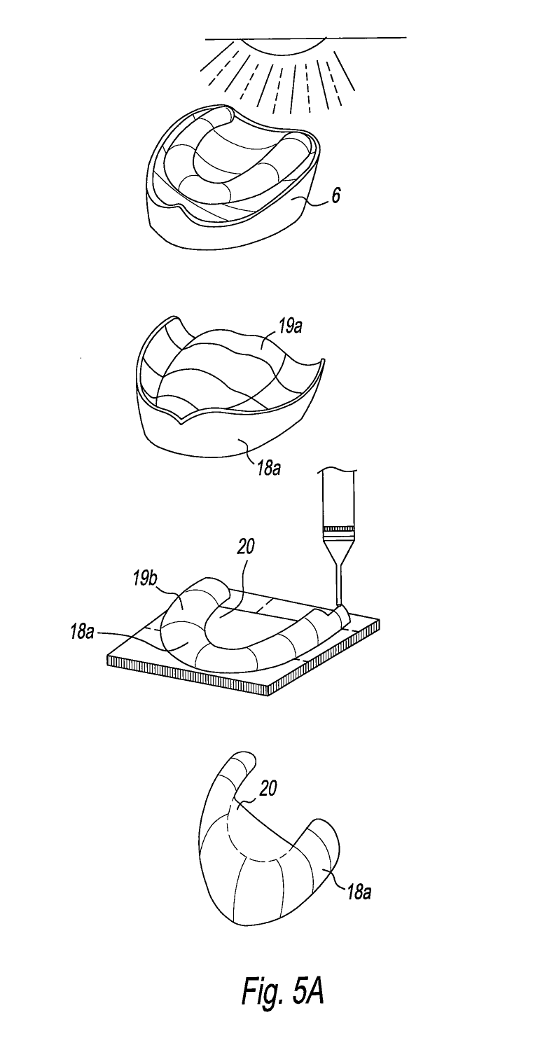

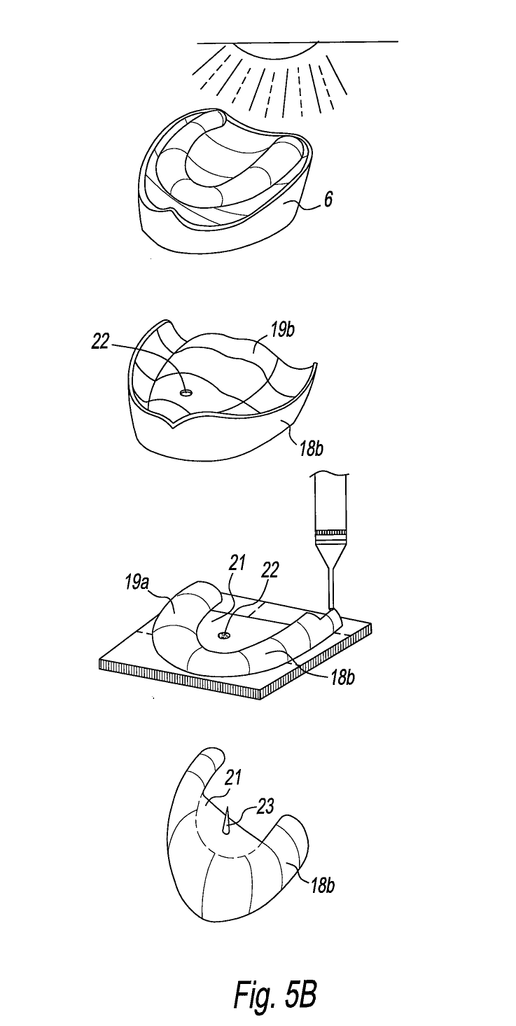

Referring to FIGS. 5A and 5B, an improved combination of base plates are shown. As discussed above in connection with FIG. 2, a stone model 6 is scanned and an upper base plate 18a (FIG. 5A) or a lower base plate 18b (FIG. 5B) are made therefrom. Of course, it is contemplated by the present disclosure for base plates 18a, 18b to be made using any technique such as that disclosed with respect to FIG. 1 of the present disclosure.

As shown in FIG. 5A, upper base plate 18a is intended for use with the upper gum and includes an upper palate facing surface 19a. Moreover, base plate 18a is fabricated with a built-in striker plate 20 on a surface 19b opposite upper palate facing surface 19a.

However, as shown in FIG. 5B, lower base plate 18b is intended for use with the lower gum and includes a lower palate facing surface 19b. Lower base plate 18b is fabricated with a built-in pin plate 21 on a surface 19b opposite lower palate facing surface 19b. In some embodiments, built-in pin plate 21 is fabricated with a pin opening 22 for receipt of a striker pin 23, while in other embodiments opening 22 is formed after the lower base plate 18b is fabricated.

Having pin plate 21 and striker plate 20 built into the base plates 18b, 18a, respectively, eliminates the need for installing them into the base plates by the dentist. In use, the dentist inserts the striker pin 23 through base plate 18b through hole 22 from palate facing surface 19b so that the pin extends from pin plate 21 as illustrated. When base plates 18a, 18b are inserted into the patient's oral cavity, striker pin 23 contacts with striker plate 20. While having the patient make common physiological movements, the dentist measures the insertion distance of striker pin 23 to adjust the vertical distance between base plates 18a and 18b and establish the proper centric relationship at the desired vertical dimension. In this manner, base plates 18a, 18b are configured for use by the dentist to require the patient to make common physiological movements such that the striker pin 23 of the lower base plate 18b forms or scores strike marks on the strike plate 20 of the upper base plate 18a.

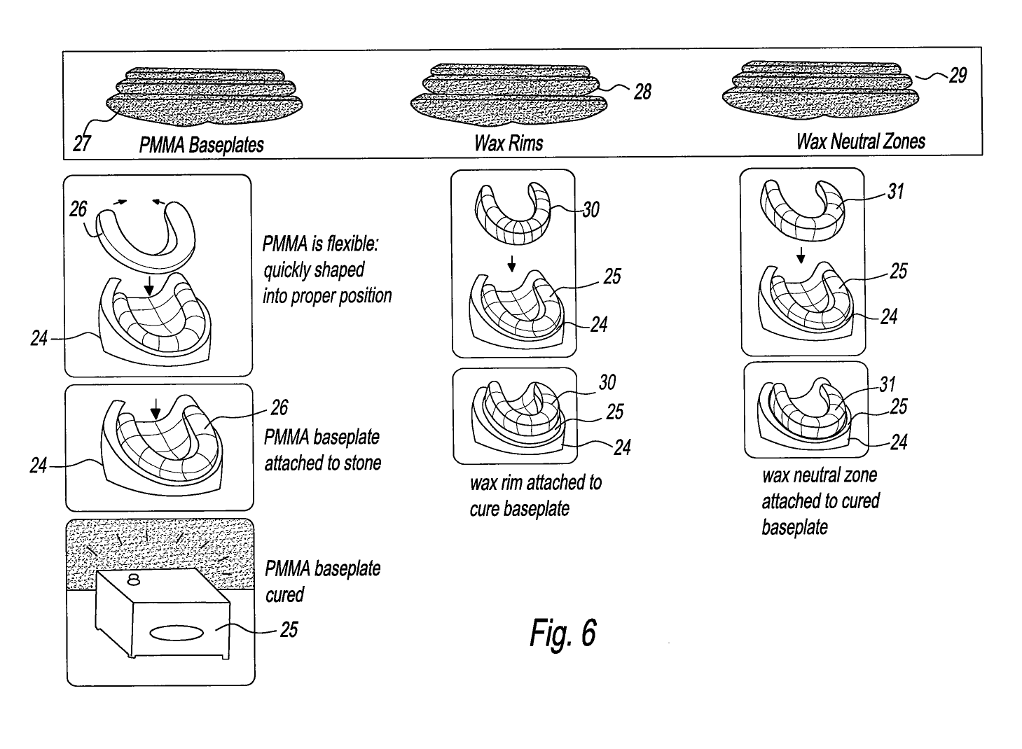

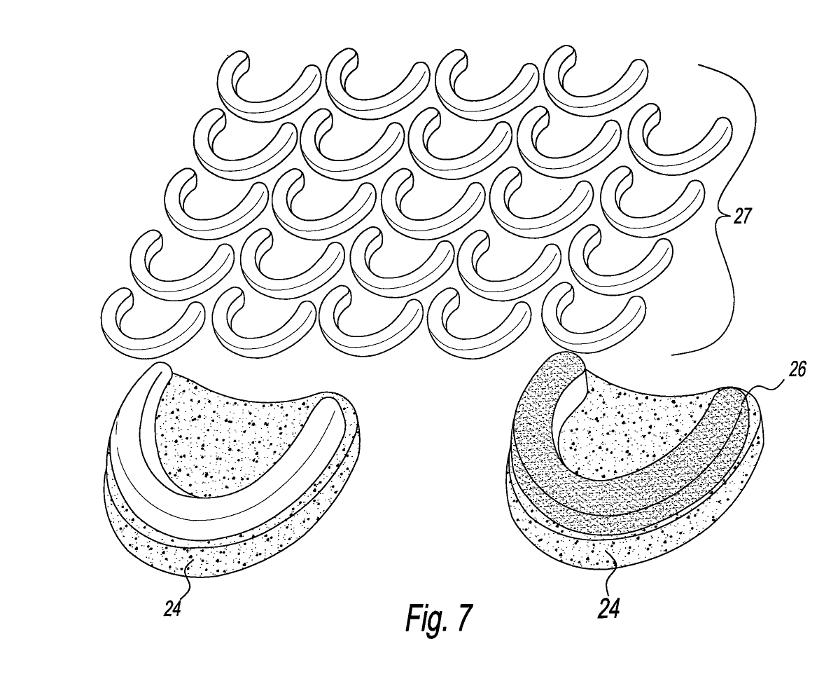

In another aspect according to the present disclosure, a custom base plate can be made from a selection of prefabricated different sized base plates, that preferably have been injection molded as shown in FIGS. 6 and 7. A measuring device can be used to measure, at several points, the width between the left and right gummy ridges of the patient. These measurements are entered into the appropriate computer, which has the information about the selection of different sized base plates. The dentist can select the correct base plate for that patient based on a correlation between the information of the different sized base plates and the measurements.

Referring now to FIG. 6, the dentist uses a stone model 24 to form a custom base plate 25. Here, stone model 24 can be formed in any desired manner. The dentist selects a preformed base plate 26 from a plurality of preformed base plates 27 that best matches the size and shape of the patient's oral cavity.

The base plate 26 is made of a formable material such as, but not limited to, a silicone, polymethacrylate (PMMA), or any plastic that solidifies upon activation, such as by heat, light or moisture. In the illustrated embodiment, base plate 26 is made of PMMA.

The dentist presses the selected base plate 26 onto stone model 24 to conform the shape of the base plate to the shape of the stone model and then solidifies the shaped base plate to form custom base plate 25.

In some embodiments such as that shown in FIG. 6, the plurality of preformed base plates 27 are formed in a substantially flat shape and are bent or otherwise deformed by the dentist when applying to the stone model 24. In other embodiments such as that shown in FIG. 7, the plurality of preformed base plates 27 are formed in a substantially arch shape and need not be bent or otherwise deformed by the dentist when applying to the stone model 24.

Also illustrated in FIG. 6, the present disclosure provides a plurality of preformed wax rims 28 and/or a plurality of preformed wax neutral zones 29. Advantageously, the plurality of preformed wax rims 28 and/or the plurality of preformed wax neutral zones 29 simplify the process of obtaining the patient's denture prescription record.

For example, in use, the dentist selects a particular wax rim 30 from the plurality of preformed wax rims 28 and secures the selected wax rim to the custom base plate 25. In this manner, the custom base plate 25 and particular wax rim 30 can be inserted into the patient's oral cavity to shape the wax rim to the patient's mouth. Similarly, the dentist selects a particular wax neutral zone 31 from the plurality of preformed wax neutral zones 29 and secures the selected neutral zone to the custom base plate 25. In this manner, the custom base plate 25 and particular wax neutral zone 31 can be inserted into the patient's oral cavity to shape the wax neutral zone to the patient's mouth.

The present disclosure has been described with particular reference to certain embodiments. It should be understood that the foregoing descriptions and examples are only illustrative of the invention. Various alternatives and modifications can be devised by those skilled in the art without departing from the spirit and scope of the present disclosure. Accordingly, the present disclosure is intended to embrace all such alternatives, modifications, and variations that fall within the scope of the appended claims.

What is claimed is:

1. A method for manufacturing a denture, comprising:
making a physical model of a first device;
digitally scanning the physical model;
computer modeling a second device based on the digital scan, wherein the second device is complimentary to the first device; and
making a physical model of the second device from the computer modeling.

2. The method according to claim 1, wherein the first device is an oral cavity and the physical model is an impression of an oral cavity, and the second device is a stone model.

3. The method according to claim 1, wherein the physical model is a stone model and the first device is an oral cavity, and the second device is a base plate.

4. The method according to claim 1, wherein the digital scan is effected by three-dimensional scanning.

5. The method according to claim 1, wherein the computer modeling is created by CAD technology.

6. A method for making a stone model for use in the manufacture of a denture, comprising:
making a physical model of an impression;
providing a container sized to hold the impression;
providing a semi-solid material in the container that becomes solid on activation;
inserting the impression into the semi-solid material, thereby forming a complimentary stone around the impression from the semi-solid material;
activating the semi-solid material to form the stone model; and
removing the stone model from the container.

7. The method according to claim 6, wherein the semi-solid material is made of any ingredient selected from the group consisting of a silicone, polymethacrylate, and any plastic that solidifies upon activation.

8. The method according to claim 6, wherein the semi-solid material is forced into the container.

9. A method of making a stone model from an impression for a denture, comprising:
placing the impression into a chamber;
heating a material from which the stone model will be made to a semi-liquid state;
dispensing the semi-liquid material into the chamber around the impression;
cooling the semi-liquid material to a solid state to form the stone model; and
removing the stone model from the chamber.

10. An apparatus for making a denture, comprising:
a pair of base plates comprising a lower base plate for a lower gum and an upper base plate for an upper gum of a patient;
a support plate in the lower base plate, the support plate having a hole therein;
a striker plate in the upper base plate; and
a pin sized to fit through the hole to contact the striker plate,
whereby the pin is inserted through the hole to adjust the vertical dimension between the upper and lower base plates and establish the proper centric relationship for the patient.
